(19) United States
(12) Patent Application Publication
(10) Pub. No.: US 2017/0269905 A1
(43) Pub. Date: Sep. 21, 2017

(54) METHOD AND APPARATUS FOR DELIVERING SOFTWARE SOLUTIONS

(71) Applicant: EMC IP Holding Company LLC, Hopkinton, MA (US)

(72) Inventors: Sandro Jiawei Wu, Shanghai (CN); Lynn Xin Lin, Shanghai (CN); Peter Yi Huang, Shanghai (CN); Bruce Yunlong Yang, Shanghai (CN); Sophia Rongyan Xia, Shanghai (CN)

(21) Appl. No.: 15/464,300

(22) Filed: Mar. 20, 2017

(30) Foreign Application Priority Data
Mar. 21, 2016 (CN) CN201610162398.8

(51) Int. Cl. G06F 9/44; G06F 9/445

(52) U.S. Cl. CPC G06F 8/10; G06F 8/60

(57) ABSTRACT

Embodiments of the present disclosure provide a method and apparatus of software solution delivery. The method comprises: receiving hardware requirements and software requirements associated with the software solution; determining, according to the hardware requirements and the software requirements, hardware resources and delivery contents associated with the software solution based on a set of predefined policies; retrieving the determined hardware resources from a pool of hardware resources; and delivering the delivery contents to the determined hardware resources. The embodiments of the present disclosure use a set of predefined policies to determine hardware resources to which a software solution will be delivered, as well as delivery contents associated with the software solution to be delivered, thereby providing an automated software solution delivery process.

### RELATED APPLICATIONS

This application claim priority from Chinese Patent Application Number CN201610162398.8, filed on Mar. 21, 2016 at the State Intellectual Property Office, China, titled “Method and Apparatus For Delivering Software Solutions” the contents of which is herein incorporated, by reference in its entirety.

### FIELD

Embodiments of the present disclosure relate to the field of computers, and more particularly, to a method and apparatus of delivering a software solution to hardware resources.

### BACKGROUND

When providing products to end users, product manufacturers usually need to, according to requirements of the end users, retrieve from a pool of hardware resources hardware resources required by the end users, deploy a desirable software solution on the retrieved hardware resources and perform related tests on the deployed software solution so as to ensure normal use by the end users.

Currently, at least one of the above acts for retrieving the hardware resources, deploying and testing the software solution is manually performed by the manufacturers. Therefore, the efficiency is quite low.

### SUMMARY

To solve the problems in one or more prior arts, there is a need for a technical solution for efficiently delivering a software resolution to hardware resources.

In a first aspect, there is provided a method of delivering a software solution. The method comprises: receiving hardware requirements and software requirements associated with the software solution; determining, according to the hardware requirements and the software requirements, hardware resources and delivery contents associated with the software solution based on a set of predefined policies; retrieving the determined hardware resources from a pool of hardware resources; and delivering the delivery contents to the determined hardware resources.

In some embodiments, receiving hardware requirements and software requirements associated with the software solution comprises: receiving hardware requirements and software requirements associated with a first software solution; and receiving hardware requirements and software requirements associated with a second software solution, the first software solution being different from the second software solution.

In some embodiments, the set of predefined policies includes a first set of predefined policies and a second set of predefined policies, the first set of predefined policies being different from the second set of predefined policies; wherein the method further comprises: assigning the first set of predefined policies to the first software solution, and assigning the second set of predefined policies to the second software solution; and wherein determining hardware resources and delivery contents associated with the software solution based on a set of predefined policies comprises: determining hardware resources and delivery contents for the first software solution based on the first set of predefined policies, and determining hardware resources and delivery contents for the second software solution based, on the second set of predefined policies.

In some embodiments, the set of predefined policies includes a set of global policies; and wherein determining hardware resources and delivery contents associated with the software solution based on a set of predefined policies comprises: determining hardware resources and delivery contents for the first software solution and for the second software solution based on the set of global policies.

In some embodiments, the set of predefined policies includes a plurality of policies, each of the plurality of policies including a mapping between a set of attributes and delivery contents, each of the attributes representing a hardware requirement or software requirement associated with a software solution to be, delivered.

In some embodiments, the plurality of policies at least include a first policy and a second policy that is different from the first policy.

In some embodiments, each of the attributes is assigned with a weight; and wherein determining hardware resources and delivery contents associated with the software solution based on a set of predefined policies comprises: comparing the received hardware requirements and software requirements with the first policy and the second policy respectively; determining, based on the comparing, a first sum of weights of attributes for the first policy that match the received hardware requirements and software requirements; determining, based on the comparing, a second sum of weights of attributes for the second policy that match the received hardware requirements and software requirements; and in response to the first sum of weights being greater than the second sum of weights, determining the hardware resources and the delivery contents based on the first policy.

In a second aspect, there is provided an apparatus for software solution delivery. The apparatus comprises: a requirement processing unit configured to receive hardware requirements and software requirements associated with the software solution and to determine, according to the hardware requirements and the software requirements, hardware resources and delivery contents associated with the software solution based on a set of predefined policies; a hardware resources management unit configured to retrieve the determined hardware resources from a pool of hardware resources; and a delivery unit configured to deliver the delivery contents to the determined hardware resources.

In some embodiments, the requirement processing unit is further configured to: receive hardware requirements and software requirements associated with a first software solution; and receive hardware requirements and software requirements associated with a second software solution, the first software solution being different from the second software solution.

In some embodiments, the set of predefined policies includes a first set of predefined policies and a second set of predefined policies, the first set of predefined policies being different from the second set of predefined policies; wherein the requirement processing unit is further configured to: assign the first set of predefined policies to the first software solution; assign the second set of predefined policies to the second software solution; determine hardware resources and delivery contents for the first software solution based on the first set of predefined policies; and determine hardware resources and delivery contents for the second software solution based on the second set of predefined policies.

In some embodiments, the set of predefined policies includes a set of global policies; and wherein the requirement processing unit is further configured to: determine hardware resources and delivery contents for the first software solution and for the second software solution based on the set of global policies.

In some embodiments, the set of predefined policies includes a plurality of policies, each of the plurality of policies including a mapping between a set of attributes and delivery contents, each of the attributes representing a hardware requirement or software requirement associated with a software solution to be delivered.

In some embodiments, the plurality of policies at least include a first policy and a second policy that is different from the first policy.

In some embodiments, each of the attributes is assigned with a weight; and wherein the requirement processing unit is further configured to: compare the received hardware requirements and software requirements with the first policy and the second policy respectively; determine, based on the comparing a first sum of weights of attributes for the first policy that match the received hardware requirements and software requirements; determine, based on the comparing, a second sum of weights of attributes for the second policy that match the received hardware requirements and software requirements; and in response to the first sum of weights being greater than the second sum of weights, determining the hardware resources and the delivery contents based on the first policy.

In a third aspect, there is provided a server, comprising: at least one processing unit; and a memory storing computer program instructions thereon which, when executed by the at least one processing unit, cause the server to perform the method according to the embodiments of the present disclosure.

In a fourth aspect, there is provided a computer program product comprising computer program instructions which, when executed by a computing device, cause the computing device to execute a method according to the embodiments of the present disclosure.

The embodiments of the present disclosure use a set of predefined policies to determine a hardware resource, to which a software solution will be delivered, as well as delivery content associated with the software solution to be delivered, thereby providing an automated software solution delivery process.

### BRIEF DESCRIPTION OF THE DRAWINGS

Through the detailed description of some embodiments of the present disclosure in the accompanying drawings, the features, advantages and other aspects of the present disclosure will become more apparent, wherein several embodiments of the present disclosure are shown for the illustration purpose only, rather than for limiting. In the accompanying drawings:

FIG. 1 is an environment in which embodiments of the present disclosure can be implemented;

FIG. 2 shows a flowchart of a method of delivering a software solution according to an embodiment of the present disclosure;

FIG. 3 shows examples of hardware requirements and software requirements;

FIG. 4 shows a block diagram of an apparatus for delivering a software solution according to an embodiment of the present disclosure;

FIG. 5 shows an architecture of an apparatus for delivering a software solution according to an embodiment of the present disclosure; and

FIG. 6 shows a schematic block diagram of a device which is applicable to implement the embodiments of the present disclosure.

### DETAILED DESCRIPTION

Principles of the present disclosure are described below by means of several exemplary embodiments as shown in the accompanying drawings. It should be understood that these embodiments are described only for enabling those skilled in the art to better understand and further implement the present disclosure, rather for limiting the scope of the present disclosure in any manner.

To increase the efficiency of delivering a software solution to hardware resources, embodiments of the present disclosure provide a technical solution for delivering a software solution to hardware resources by policy driving.

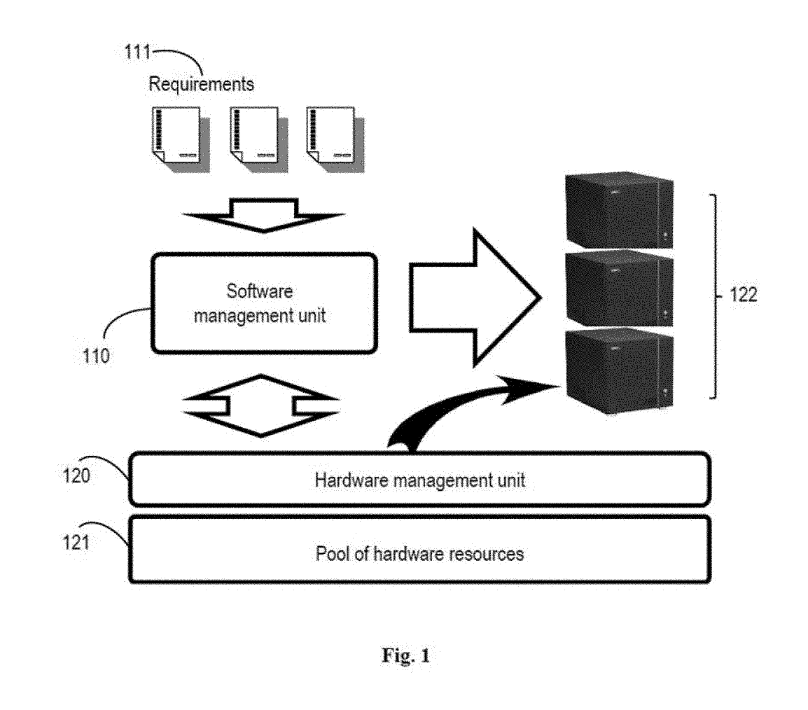

FIG. 1 shows a block diagram of an exemplary environment 100 in which the embodiments of the present disclosure may be implemented. As shown in FIG. 1, environment 100 comprises a software management unit 110 and a hardware resource management unit 120.

Software management unit 110 is configured to receive, from an end user, requirements 111 that are associated with a software solution to be delivered. Requirements 111 may include hardware requirements and software requirements associated with the software solution. Software management unit 110 is further configured to, according to the requirements 111, determine hardware resources to which the software solution will be delivered based on a set of predefined policies.

In addition, software management unit 110 is further configured to communicate with hardware resource management unit 120 such that hardware resource management unit 120 retrieves the determined hardware resources, such as hardware resources 122 from a pool of hardware resources 121. In some embodiments, hardware resources in the pool of hardware resources 121 may include converged infrastructure (CI) resources. In other embodiments, hardware resources in the pool of hardware resources 121 may include customized resources.

Furthermore, software management unit 110 is configured to determine delivery contents associated with the software solution based on the set of predefined policies and deliver the delivery contents to the retrieved hardware resources 122.

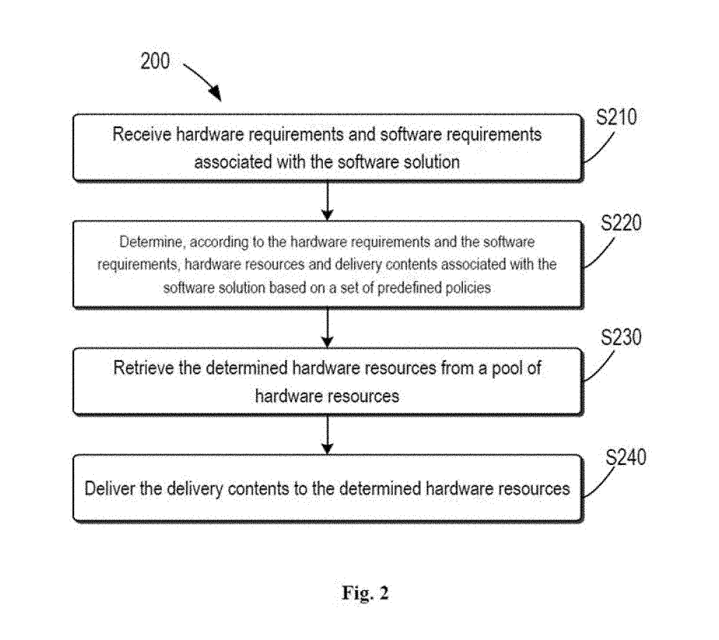

FIG. 2 shows a flowchart of a method 200 for delivering a software solution according to an embodiment of the present disclosure. In some embodiments, the method 200 may be implemented by software management unit 110 and hardware resource management unit 120 as shown in FIG. 1. Therefore, with reference to FIG. 2 and by means of exemplary environment 100 as shown in FIG. 1, detailed description is presented below to the method of delivering a software solution according to an embodiment of the present disclosure.

As shown in FIG. 2, in S210, the software management unit 110 receives from the end user requirements 111 that are associated with a software solution to be delivered. Requirements 111 may include software requirements and hardware requirements associated with the software solution to be delivered.

As one example, the software requirements associated with the software solution to be delivered may include a name of the software solution to be delivered, such as a HR management scheme, a financial management scheme and the like.

As one example, the hardware requirements associated with the software solution to be delivered may include a model name of the desired hardware resources, such as Quanta, Rinjin and the like. In addition, the hardware requirements associated with the software solution to be delivered may include computation requirements and storage requirements, such as CPU requirements and storage capacity requirements.

It may be understood the software solution usually comprises a plurality of packages. In this regard, the software requirements associated with the software solution to be delivered may comprise names of packages in the software solution, such as Apache Server 1.0, MySQL Database 2.1, etc.

Still with reference to FIG. 2, in S220, the software management unit 110, according to the hardware requirements and software requirements associated with the software solution to be delivered, determines hardware resources and delivery contents associated with the software solution based on a set of predefined policies. As one example, the set of predefined policies may be maintained and managed by using a policy database.

In some embodiments, the delivery contents associated with the software solution include deployment contents. Examples of the deployment contents include, but are not, limited to, a set of deployment scripts, packages associated with deployment scripts, and configuration files.

In some embodiments, the delivery contents associated with the software solution further include test contents. Examples of the test contents include, but are not limited to, a set of test scripts, sequence files and related executable files.

In some embodiments, the set of predefined policies may be specific to the software solution to be delivered. In other words, different sets of policies are adopted for different software solutions so that the situation that the same requirements match a plurality of policy items may be avoided.

Specifically, receiving hardware requirements and software requirements associated with the software solution may comprise: receiving hardware requirements and software requirements associated with a first software solution; and receiving hardware requirements and software requirements associated with a second software solution. The first software solution is different from the second software solution. The set of predefined policies may include a first set of predefined policies and a second set of predefined policies. The first set of predefined policies is different from the second set of predefined policies. In this regard, the method 200 may further comprise assigning the first set of predefined policies to the first software solution; and assigning the second set of predefined policies to the second software solution. Determining the hardware resources and the delivery contents associated with the software solution based on the set of predefined policies may comprise: determining hardware resources and delivery contents for the first software solution based on the first set of predefined policies; and determining hardware resources and delivery contents for the second software solution based on the second set of predefined policies.

According to the embodiments of the present disclosure, the set of predefined policies includes a plurality of policies. Each of the plurality of policies includes a mapping between a set of attributes and delivery contents. Each of the attributes represents hardware requirements or software requirements associated with a software solution to be delivered.

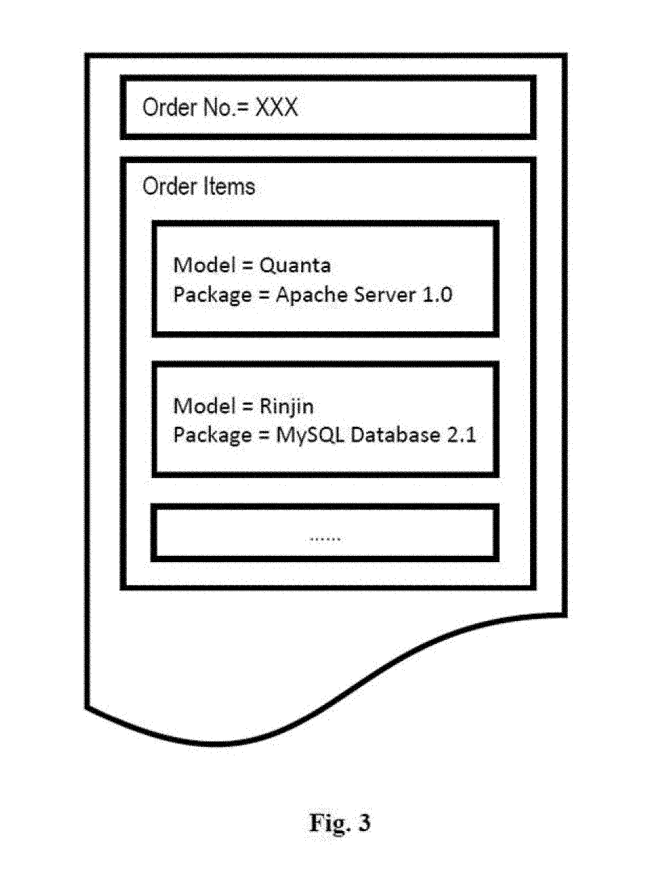

It may be understood that in practice, the end user may use any appropriate means to put forward software requirements and hardware requirements associated with a desired software solution. For example, the end user may put forward the software requirements and hardware requirements by an order, as shown in FIG. 3.

The order as shown in FIG. 3 includes an order number. It should be understood that in this example, the order number is associated with a software solution to be delivered in advance. Thereby, the order number implicitly indicates the software solution to be delivered. Alternatively, instead of the order number, the software solution to be delivered may be explicitly indicated in the order by a name of the software solution to be delivered.

The order as shown in FIG. 3 further includes a plurality of order items. Each of the plurality of order items includes a model name of desired hardware resources (e.g., Quanta or Rinjin) and a name of a package that is to be delivered to the hardware resources (e.g., Apache Server 1.0 or MySQL Database 2.1).

In conjunction with FIG. 3 and with reference to Tables 1 to 4 below, description is presented to an embodiment in which a set of predefined policies is specific to a software solution to be delivered.

TABLE 1

If: Model = Quanta, Order No. = 12345
Then: profile = High,
deploy = ApacheHigh_1.2,
test = ApacheTest_1.1

TABLE 2

If: Model = Quanta, Order No. = 12345,
Package = Apache_1.0
Then: OS = Ubuntu,
deploy = ApacheHigh_1.2,
test = ApacheTest_1.1

TABLE 3

If: Model = Rinjin, Order No. = 12345
Then: profile = Medium,
deploy = ApacheMedium_1.1,
test = ApacheTest_1.1

TABLE 4

If: Model = Rinjin, Order No. = 12345,
Package = Apache_1.0
Then: OS = Ubuntu,
deploy = ApacheMedium_1.1,
test = ApacheTest_1.1

The name (not shown) of the software solution to be delivered may be, for example, “HR management scheme”. As described above with reference to FIG. 3, the order number may be associated with the software solution to be delivered in advance. Thereby, the order number “12345” in Tables 1 to 4 implicitly indicates the software solution to be delivered. Tables 1 to 4 show examples of a policy set that is specific to the order number “12345” (i.e., specific to the “HR management scheme”), wherein each of Tables 1 to 4 shows one policy in the policy set.

According to the embodiments of the present disclosure, the set of predefined policies includes a plurality of policies. Each of the plurality of policies includes a mapping between a set of attributes and delivery contents. Each of the attributes represents hardware requirements or software requirements associated with a software solution to be delivered.

For example, the policy as shown in Table 2 includes a set of attributes composed of attributes “Model”, “Order No.” and “Package”, wherein the attribute “Model” represents hardware requirements associated with the software solution to be delivered, and the attributes “Order No.” and “Package” represent software requirements associated with the software solution to be delivered.

In addition, as shown in Table 2, the delivery contents may include deployment content, such as ApacheHigh_1.2. Furthermore, as shown in Table 2, the delivery contents may further include test content, such as ApacheTest_1.1. Besides, the delivery content may further optionally include content that is related to an, operating system (OS), such as Ubuntu. It should be understood the policy may not include content that is related to an operating, system. In this case, the default operating system may be loaded to hardware resources according to the model of the hardware resources.

In some embodiments, the set of predefined policies may not be specific to a software solution to be delivered but be a set of global policies. In other words, the same policy set is adopted for different software solutions. In this case, determining the hardware resources and the delivery contents associated with the software solution based on the set of predefined policies comprises: determining hardware resources and delivery contents for the first software solution based on the set of global policies; and determining hardware resources and delivery contents for the second software solution based on the set of global policies. In some embodiments, the plurality of policies at least include a first policy, and a second policy that is different from the first policy, and each attribute in the set of attributes for each of the first and second policies may be assigned a weight.

In this case, determining hardware resources and delivery contents associated with the software solution based on a set of predefined policies comprises: comparing the received hardware requirements and software requirements with the first policy and the second policy respectively; determining, based on the comparing, a first sum of weights of attributes for the first policy that match the received hardware requirements and software requirements; determining, based on the comparing, a second sum of weights of attributes for the second policy that match the received hardware requirements and software requirements; and in response to the first sum of weights being greater than the second sum of weights, determining the hardware resources and the delivery contents based on the first policy.

For example, the first policy includes a policy as shown in Table 2, and the second policy includes a policy as shown in Table 4. Attributes “Model”, “Order No.” and “Package” of the policy as shown in Table 2 may be assigned weights 0.2, 0.3 and 0.5 respectively. Attributes “Model”, “Order No.” and “Package” of the policy as shown in Table 4 may be assigned weights 0.3, 0.4 and 0.3 respectively.

For example, if the received hardware requirement and software requirement are “Model=Quanta” and “Package=Apache Server 1.0” respectively, the following operations may be performed when determining whether the policy as shown in Table 2 or the policy as shown in Table 4 is used for determining the hardware resources and the delivery contents. The received hardware requirement and software requirement are compared with the policy as shown in Table 2 and the policy as shown in Table 4 respectively. Based on the comparing, a first sum of weights of attributes matching the received requirement as 0.7 (i.e., 0.2+0.5) for the policy in Table 2 is determined, and a second sum of weights of attributes matching the received requirement as 0.6 (i.e., 0.3+0.3) for the policy in Table 4 is determined. If the first sum of weights for the policy in Table 2 is greater than the second sum of weights for the policy in Table 4, the hardware resource and the delivery contents are determined based on the policy shown in Table 2.

Thereby, in the embodiment where the set of global policies is adopted, the situation where the same requirement matches a plurality of policies may be avoided by assigning a weight to each attribute of each policy.

It should be understood the set of policies specific to the software solution to be delivered and the set of global policies as described above are merely examples of the set of predefined policies. According to an application scenario, the manufacturer may predefine any appropriate set of policies other than the above-described sets of policies, and the embodiments of the present disclosure are not limited in this regard.

Still with reference to FIG. 2, in S230, the hardware resource management unit 120 retrieves the determined hardware resources from the pool of hardware resources 121. In S240, the software management unit 110 delivers the determined delivery contents to the determined hardware resources.

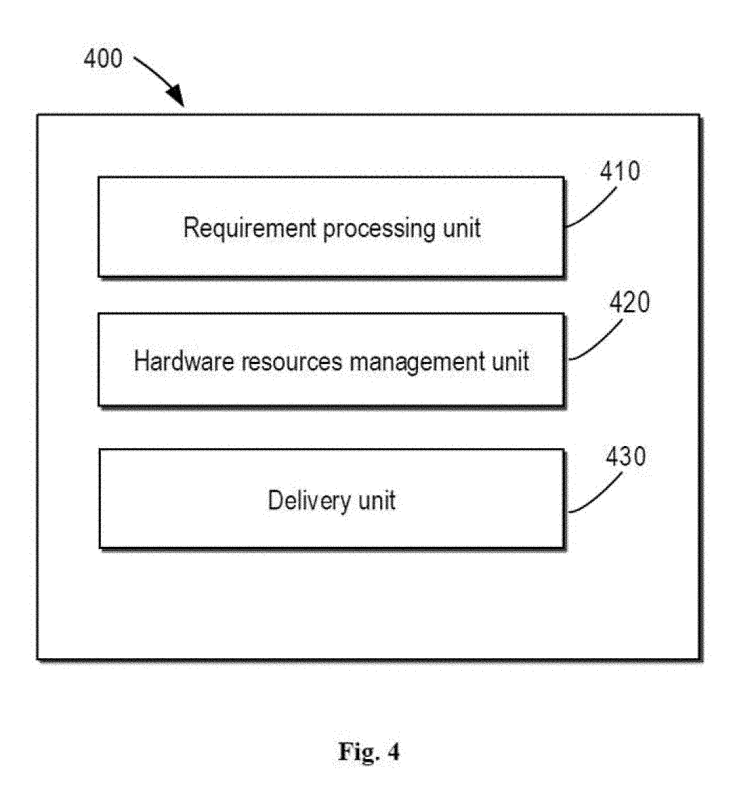

FIG. 4 shows a block diagram of an apparatus 400 for software solution delivery according to an embodiment of the present disclosure. In some embodiments, apparatus 400 may be implemented in the environment 100 shown in FIG. 1.

As shown in FIG. 4, the apparatus 400 comprises: a requirement processing unit 410 configured to receive hardware requirements and software requirements associated with the software solution and to determine, according to the hardware requirements and the software requirements, hardware resources and delivery contents associated with the software solution based on a set of predefined policies; a hardware resources management unit 420 configured to retrieve the determined hardware resources from a pool of hardware resources; and a delivery unit 430 configured to deliver the delivery contents to the determined hardware resources.

In some embodiments, the requirement processing unit 410 is further configured to: receive hardware requirements and software requirements associated with a first software solution; and receive hardware requirements and software requirements associated with a second software solution, the first software solution being different from the second software solution.

In some embodiments, the set of predefined policies includes a first set of predefined policies and a second set of predefined policies, the first set of predefined policies being different from the second set of predefined policies; wherein the requirement processing unit 410 is further configured to: assign the first set of predefined policies to the first software solution; assign the second set of predefined policies to the second software solution; determine hardware resources and delivery contents for the first software solution based on the first set of predefined policies; and determine hardware resources and delivery contents for the second software solution based on the second set of predefined policies.

In some embodiments, the set of predefined policies includes a set of global policies; and wherein the requirement processing unit 410 is further configured to: determine hardware resources and delivery contents for the first software solution and for the second software solution based on the set of global policies.

In some embodiments, the set of predefined policies includes a plurality of policies, each of the plurality of policies including a mapping between a set of attributes and delivery contents, each of the attributes representing a hardware requirement or software requirement associated with a software solution to be delivered.

In some embodiments, the plurality of policies at least include a first policy and a second policy that is different from the first policy.

In some embodiments, each of the attributes is assigned with a weight. The requirement processing unit 410 is further configured to: compare the received hardware requirements and software requirements with the first policy and the second policy respectively; determine, based on the comparing, a first sum of weights of attributes for the first policy that match the received hardware requirements and software requirements; determine, based on the comparing, a second sum of weights of attributes for the second policy that match the received hardware requirements and software requirements; and in response to the first sum of weights being greater than the second sum of weights, determining the hardware resources and the delivery contents based on the first policy.

The embodiments of the present disclosure further provide a server, comprising: at least one processing unit; and a memory storing computer program instructions thereon which, when executed by the at least one processing unit, cause the server to perform the method according to the embodiments of the present disclosure.

The embodiments of the present disclosure further provide a computer program product including computer program instructions which, when executed on a computing device, cause the computing device to perform the method according to the embodiments of the present disclosure.

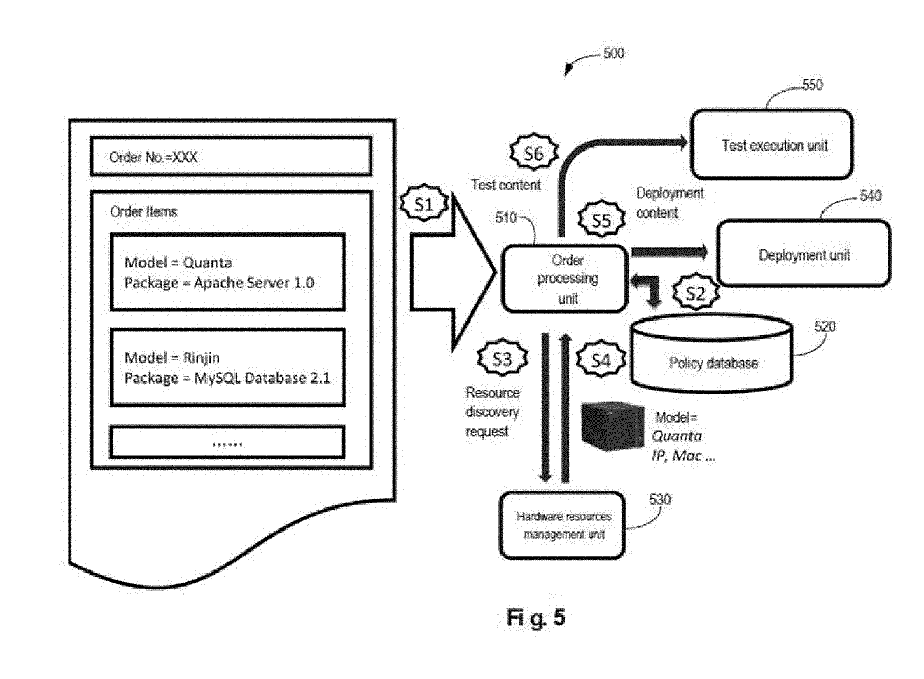

FIG. 5 shows an architecture view of an apparatus 500 for software solution delivery according to the embodiments of the present disclosure. The apparatus 500 may serve as one exemplary implementation of the environment 100 shown in FIG. 1.

As shown in FIG. 5, the apparatus 500 comprises an order processing unit 510, a deployment unit 540 and a test execution unit 550. In some embodiments, the order processing unit 510 may be implemented in the software management unit 110 in FIG. 1 or requirement processing unit 410 in FIG. 4. In some embodiment, the deployment unit 540 and test executing unit 550 may be implemented in the software management unit 110 in FIG. 1 or delivery unit 430 in FIG. 4.

As one example, the order processing unit 510, deployment unit 540 and test executing unit 550 may be implemented by being loaded to existing software management tools. Examples of the existing software management tools include, but not limited to, Cumulus. As known, Cumulus is a cloud based manufacturing solution, whose target is to move all the common computation and storage requirements of the manufacturing process to a cloud based platform in a data center.

The apparatus 500 further comprises a hardware resources management unit 530. In some embodiments, the hardware resources management unit 530 may be implemented in the hardware resources management unit 120 in FIG. 1 or hardware resources management unit 420 in FIG. 4. As one example, the hardware resources management unit 530 may be implemented by means of existing hardware management tools. Examples of the existing software management tools include, but not limited to, OnRack. As is well known in the art, OnRack is a CI management and coordination software, which provides the functionality required by an infrastructure management and coordination layer of software. Furthermore, OnRack provides a set of software abstractions that hide the details of the converged infrastructure from the infrastructure management and coordination layer. These software abstractions will take the form of RESTful and publish/subscribe APIS. By providing these sorts of APIs, the infrastructure layer can be located anywhere on a network which can communicate with OnRack management and coordination tools.

In conjunction with FIG. 5 and by referring to above-described Tables 1 and 2, description is presented below to operations of various units of the apparatus 500.

In S1, the order processing unit 510 receives software requirements and hardware requirements associated with a software solution to be delivered which are provided in the form of an order by the user, and parse the received order.

In S2, with respect to each order item, the order processing unit 510 accesses a policy database 520 by “order number” and “model name”, so as to determine the corresponding hardware resource profile via Table 1. For example, the order processing unit 510 accesses policy database 520 by the order number “12345” and the model name “Quanta” so as to map out the corresponding resource profile “High (high profile)” therefrom. This means the software solution that is implicitly indicated by the order number “12345” needs to be delivered to the hardware resource having the model name “Quanta” and the resource profile “High (high profile)”. It should be understood “High (high profile)”, “Medium (medium profile)” and “Low (low profile)” may be predefined by the manufacturer.

In S3, the order processing unit 510 sends a resource discovery request to hardware resources management unit, the request containing the model name “Quanta” and the resource profile “High” determined in S2.

In response to receiving the resource discovery request, the hardware resources management unit 530 determines from a pool of hardware resources (not shown) a hardware resources set that matches the model name “Quanta” and the resource profile “High”, selects an available hardware resource from the determined hardware resources set, and sends the selected hardware resource information to the order processing unit 510 in S4. As shown in FIG. 5, the selected hardware resource information may include, for example, the model name “Quanta”, an IP address, a MAC address, etc. In addition, optionally, the hardware resources management unit 530 may load an appropriate operating system to the selected hardware resource. Alternatively, the order processing unit 510 may load an appropriate operating system to the selected hardware resource.

Next, the order processing unit 510 accesses the policy database 520 by the “order number”, “model name” and “package name”, so as to determine deployment content and test content associated with the software solution via Table 2 for example. The order processing unit 510 uses the order number “12345”, the model name “Quanta” along with the package name “Apache_1.0” to access the policy database 520, so as to map out the corresponding deployment content “ApacheHigh_1.2” and test content “ApacheTest_1.1” from the policy database 520. This means “ApacheHigh_1.2” will be deployed on the hardware resource selected by the hardware resources management unit 530 and test “ApacheTest_1.1” will be performed on the same. In addition, the deployment content obtained by the order processing unit 510 in this step further includes the name “Ubuntu” of the corresponding operating system image. The hardware resources management unit 530 may load the determined operating system to the selected hardware resource. Alternatively, the hardware resources management unit 530 may load the default operating system to the hardware resource according to the model of the hardware resource.

In S5, the order processing unit 510 provides the determined deployment unit (package) to the deployment unit 540, so that the deployment content may be extracted and pushed onto the selected hardware resource and the deployment scripts may be run on the selected hardware resource. Alternatively, the selected hardware resource may download the extracted deployment content. In addition, operations performed by the deployment unit 540 may further comprise hypervisor installation, VM creation, system configuration and additional software application deployment, etc.

In S6, the order processing unit 510 provides the determined test content (package) to the test execution unit 550 for test. Specifically, for example, in the implementation of adding test execution unit 550 to Cumulus, the Cumulus Sequencer may be used to drive the execution of Python format test scripts. The workflow may be defined with a python format sequence file. In addition, the test result as well as error details will be collected, by test execution unit 550 and displayed to the end user for further analysis.

It may be understood the embodiments of the present disclosure provides an automated software solution delivery process by using a set of predefined policies. In addition, a unified software solution delivery platform may be provided when combining the delivery process according to the embodiments of the present disclosure with Cumulus and OnRack. Specifically, Cumulus is highly scalable, as its capacity depends only on the number of test execution systems and deployment systems, and each system can support 100 or more hardware resources. The manufacturer can very quickly increase the number of test execution systems and deployments systems, without causing any additional difficulty in the operations. Cumulus also supports executing different deployment policies and test policies on the same machine. This makes it possible to deliver multiple solutions at the same time without any difficulty. Furthermore, OnRack provides a unified API for resource discovery and configuration reading. This makes it possible to discover target resources automatically.

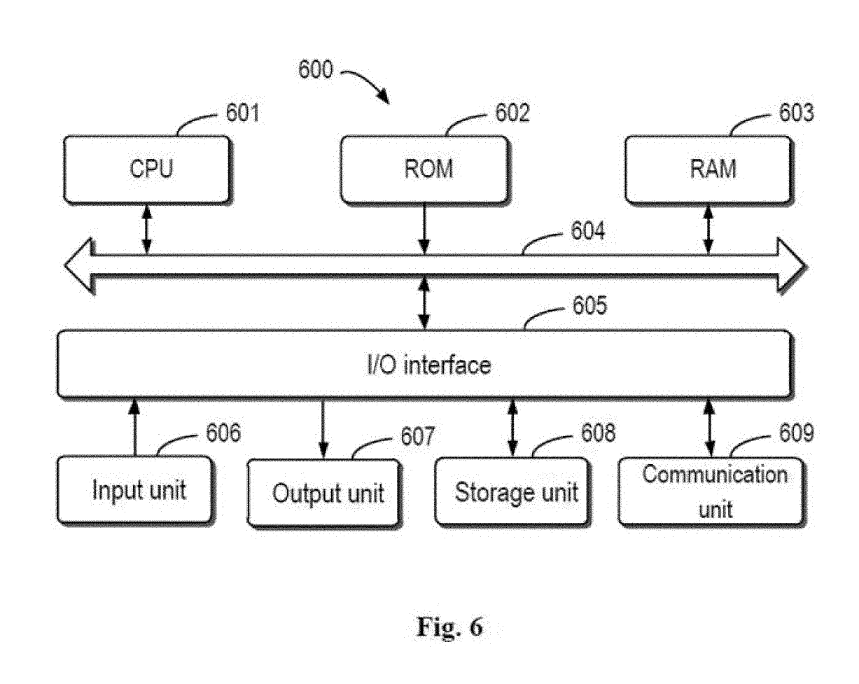

FIG. 6 shows a schematic block diagram of a device 600 suitable for implementing the embodiments of the present disclosure. As shown, device 600 comprises a central processing unit (CPU) 601 which is capable of performing various processes in accordance with a program stored in a read only memory (ROM) 602 or a program loaded from a storage unit 608 to a random access memory (RAM) 603. In RAM 603, data required when CPU 601 performs the various processes or the like is also stored as required. CPU 601, ROM 602 and RAM 603 are connected to one another via a bus 604. An input/output (I/O) interface 605 is also connected to bus 604.

A plurality of components in device 600 are connected to I/O interface 605, comprising: an input unit 606 including a keyboard, a mouse, or the like; an output unit 607 including a display such as a cathode ray tube (CRT), a liquid crystal display (LCD), or the like, and a loudspeaker or the like; a storage unit 608 including a hard disk or the like; and a communication unit 609 including a network interface card such as a LAN card, a modem, or the like. Communication unit 609 allows device 600 to exchange information/data with other device via the computer network such as the interact and/or various telecommunication network.

The processes described above, such as method 100, may be executed by processing unit 601. For example, in some embodiments, method 100 may be implemented as computer software programs tangibly embodied on a machine readable medium, such as storage unit 608. In some embodiments, part or all of the computer program may be loaded and/or installed to device 600 via ROM 602 and/or communication unit 609. The computer program, when loaded to RAM 603 and executed by CPU 601, may execute one or more steps of above-described method 100.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor OT other computing device. While various aspects of the example embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product comprising a computer program tangibly embodied on a machine readable medium, the computer program containing program codes configured to carry out the methods as described above.

In the context of the disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present disclosure may be written in any combination of one or more programming languages. These computer program codes may be provided to a processor of a general purpose computer, special purpose computer, or other programmable data processing apparatus, such that the program codes, when executed by the processor of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of any disclosure or of what may be claimed, but rather as descriptions of features that may be specific to particular embodiments of particular disclosures. Certain features that are described in this specification in the context of separate embodiments may also be implemented in combination in a single embodiment. Conversely, various features that are described in the context of a single embodiment may also be implemented in multiple embodiments separately or in any suitable sub-combination.

Various modifications, adaptations to the foregoing example embodiments of this disclosure may become apparent to those skilled in the relevant arts in view of the foregoing description, when read in conjunction with the accompanying drawings. Any and all modifications will still fall within the scope of the non-limiting and example embodiments of this disclosure. Furthermore, other embodiments of the disclosures set forth herein will come to mind to one skilled in the art to which these embodiments of the disclosure pertain having the benefit of the teachings presented, in the foregoing descriptions and the drawings.

It will be appreciated that the embodiments of the present disclosure are not to be limited to the specific embodiments as discussed above and that modifications and other embodiments are intended to be included within the scope of the appended claims. Although specific terms are used herein, they are used in a generic and descriptive sense only and not for purposes of limitation.

1. A method, of delivering a software solution, comprising:
receiving hardware requirements and software requirements associated with the software solution;
determining, according to the hardware requirements and the software requirements, hardware resources and delivery contents associated with the software solution based on a set of predefined policies;
retrieving the determined hardware resources from a pool of hardware resources; and
delivering the delivery contents to the determined hardware resources.

2. The method according to claim 1, wherein receiving hardware requirements and software requirements associated with the software solution comprises:
receiving hardware requirements and software requirements associated with a first software solution; and
receiving hardware requirements and software requirements associated with a second software solution, the first software solution being different from the second software solution.

3. The method according to claim 2, wherein the set of predefined policies includes a first set of predefined policies and a second set of predefined policies, the first set of predefined policies being different from the second set of predefined policies;
wherein the method further comprises:
assigning the first set of predefined policies to the first software solution, and
assigning the second set of predefined policies to the second software solution; and
wherein determining hardware resources and delivery contents associated with the software solution based on a set of predefined policies comprises:
determining hardware resources and delivery contents for the first software solution based on the first set of predefined policies, and
determining hardware resources and delivery contents for the second software solution based on the second set of predefined policies.

4. The method according to claim 2, wherein the set of predefined policies includes a set of global policies; and
wherein determining hardware resources and delivery contents associated with the software solution based on a set of predefined policies comprises:
determining hardware resources and delivery contents for the first software solution and for the second software solution based on the set of global policies.

5. The method according to claim 1, wherein the set of predefined policies includes a plurality of policies, each of the plurality of policies including a mapping between a set of attributes and delivery contents, each of the attributes representing a hardware requirement or software requirement associated with a software solution to be delivered.

6. The method according to claim 5, wherein the plurality of policies at least include a first policy and a second policy that is different from the first policy.

7. The method according to claim 6, wherein each of the attributes is assigned with a weight; and
wherein determining hardware resources and delivery contents associated with the software solution based on a set of predefined policies comprises:
comparing the received hardware requirements and software requirements with the first policy and the second policy respectively;
determining, based on the comparing, a first sum of weights of attributes for the first policy that match the received hardware requirements and software requirements;
determining, based on the comparing, a second sum of weights of attributes for the second policy that match the received hardware requirements and software requirements; and
in response to the first sum of weights being greater than the second sum of weights, determining the hardware resources and the delivery contents based on the first policy.

8. An apparatus for software solution delivery, comprising:
a requirement processing unit configured to receive hardware requirements and software requirements associated with the software solution and to determine, according to the hardware requirements and the software requirements, hardware resources and delivery contents associated with the software solution based on a set of predefined policies;
a hardware resources management unit configured to retrieve the determined hardware resources from a pool of hardware resources; and
a delivery unit configured to deliver the delivery contents to the determined hardware resources.

9. The apparatus according to claim 8, wherein the requirement processing unit is further configured to:
receive hardware requirements and software requirements associated with a first software solution; and
receive hardware requirements and software requirements associated with a second software solution, the first software solution being different from the second software solution.

10. The apparatus according to claim 9, wherein the set of predefined policies includes a first set of predefined policies and a second set of predefined policies, the first set of predefined policies being different from the second set of predefined policies;
wherein the requirement processing unit is further configured to:
assign the first set of predefined policies to the first software solution;
assign the second set of predefined policies to the second software solution;
determine hardware resources and delivery contents for the first software solution based on the first set of predefined policies; and
determine hardware resources and delivery contents for the second software solution based on the second set of predefined policies.

11. The apparatus according to claim 9, wherein the set of predefined policies includes a set of global policies; and
wherein the requirement processing unit is further configured to:
determine hardware resources and delivery contents for the first software solution and for the second software solution based on the set of global policies.

12. The apparatus according to claim 8, wherein the set of predefined policies includes a plurality of policies, each of the plurality of policies including a mapping between a set of attributes and delivery contents, each of the attributes representing a hardware requirement or software requirement associated with a software solution to be delivered.

13. The apparatus according to claim 12, wherein the plurality of policies at least include a first policy and a second policy that is different from the first policy.

14. The apparatus according to claim 13, wherein each of the attributes is assigned with a weight; and
wherein the requirement processing unit is further configured to:
compare the received hardware requirements and software requirements with the first policy and the second policy respectively;
determine, based on the comparing, a first sum of weights of attributes for the first policy that match the received hardware requirements and software requirements;
determine, based on the comparing, a second sum of weights of attributes for the second policy that match the received hardware requirements and software requirements; and
in response to the first sum of weights being greater than the second sum of weights, determining the hardware resources and the delivery contents based on the first policy.

15-16. (canceled)
